(19) United States
(12) Patent Application Publication
(10) Pub. No.: US 2019/0232796 A1
(43) Pub. Date: Aug. 1, 2019

(54) AUTONOMOUS NETWORKED TRANSPORTATION SYSTEM AND METHOD

(71) Applicant: Robert Applegate, Johns Island, SC (US)

(72) Inventor: Robert Applegate, Johns Island, SC (US)

(21) Appl. No.: 16/262,678

(22) Filed: Jan. 30, 2019

Related U.S. Application Data
(60) Provisional application No. 62/623,868, filed on Jan. 30, 2018.

(51) Int. Cl. B60L 13/03; H02K 7/00; H02K 7/102; H02K 7/18; H02S 10/12; H02S 10/20; H02S 10/40; H02S 20/23; B60L 7/10; B60L 5/24; B60L 8/00; B61B 1/02; B61B 13/10; B61C 7/04; B60M 1/30; B60M 1/13; B60M 7/00; F03D 9/32; F03D 9/11; F15D 1/00

(52) U.S. Cl. CPC B60L 13/03; H01M 10/0525; H02K 7/102; H02K 7/183; H02S 10/12; H02S 10/20; H02S 10/40; H02S 20/23; B60L 7/10; B60L 5/24; B60L 8/003; B61B 1/02; B61B 13/10; B61C 7/04; B60M 1/30; B60M 1/13; B60M 7/00; F03D 9/32; F03D 9/11; F15D 1/0075; H02K 7/006

(57) ABSTRACT

A transportation system is disclosed herein. The transportation system may be useful to convey a user from an origin to a destination. The transportation system includes a network of enclosed passageways, roadway lanes passing though and networking within the passageways, vehicles able to pass along the roadway lanes within the passageways, and multiple passenger terminals dispersed along the passageways to effect boarding of passengers onto the vehicles. The passageways have an interior for containing the rails and vehicles, and an exterior. The vehicle has at least one induction motor for propulsion which engages the electromagnetic rail, a storage device electrically powering the motor, and a braking system able to decelerate the vehicle.

### CROSS-REFERENCE TO RELATED APPLICATION(S)

The present application is related to and claims priority to U.S. Provisional Patent Application No. 62/623,868 filed Jan. 30, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of transportation of existing art and more specifically relates to electric mass transit systems.

### RELATED ART

Current transportation systems offer significant freedom and autonomy but have severe drawbacks as well. For example, poor human driving causes most accidents, and gasoline engines create environmental damage. Most accidents occur on urban freeway ring roads and access roads, where traffic and right-of-way interactions have little oversight. A suitable solution is desired.

U.S. Pat. No. 4,361,202 to Michael Minovitch relates to an automated road transportation system. The described automated road transportation system includes a system for vehicular travel along a roadway. The roadway can be any hard surface that contains an embedded metallic guiderail along its center. A proximity transducer (metal detector) installed under the vehicle, senses the metallic guiderail and sends steering commands to the vehicle's steering actuators to keep the vehicle moving in the center of the roadway directly over the guiderail. Transponders are embedded along the guiderail at selected points for automatic roadway identification, position determination and automatic speed, headway and route selection and automatic traffic control. The system also provides automatic branching and lane changing. The vehicle's control system includes sensors, signal processors, a microprocessor and various power actuators that are connected to the vehicle's steering, braking and accelerator systems.

### SUMMARY OF THE INVENTION

In view of the foregoing disadvantages inherent in the known electric mass transit system art, the present disclosure provides a novel pathway to a fully autonomous networked transportation system and method. The general purpose of the present disclosure, which will be described subsequently in greater detail, is to provide an autonomous networked transportation system and method.

A flexible transportation system is disclosed herein. The transportation system may be useful to convey a user from an origin to a destination. The transportation system includes a network of enclosed passageways, roadway lanes passing though and networking within the passageways, vehicles able to pass along the roadway lanes within the passageways, and multiple passenger terminals dispersed along the passageways to effect boarding of passengers onto the vehicles. The passageways have an interior for containing the rails and vehicles, and an exterior. The vehicle has at least one induction motor for propulsion which engages the electromagnetic rail, a storage device electrically powering the motor, and a braking system able to decelerate the vehicle.

Vehicles will have at least one electric induction motors for propulsion and may periodically engage an electromagnetic rail. Blade turbines and regeneration braking charge the batteries that powering the wheel-based motors. Although braking occurs by slowing the motors and turning them inward, a separate emergency conventional breaking system may be added directly to the axles.

According to another embodiment, a method of transporting and networking passengers is also disclosed herein. The method of transporting and networking passengers includes providing the above-described transportation system, docking the vehicle at one of the passenger terminals, boarding the user from one of the passenger terminals into the vehicle, and driving the electric motor to propel the vehicle along the rail.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an autonomous networked transportation system and method, constructed and operative according to the teachings of the present disclosure.

FIG. 1 is a perspective view of the transportation system during an ‘in-use’ condition, according to an embodiment of the disclosure.

FIG. 2 is a perspective view of the vehicle of the transportation system of FIG. 1, according to an embodiment of the present disclosure.

FIG. 3 is a perspective view of the transportation system of FIG. 1, according to an embodiment of the present disclosure.

FIG. 4 is a side view of the enclosed passageway of the transportation system of FIG. 1, according to an embodiment of the present disclosure.

FIG. 5 shows multiple perspective views of the vehicle of the transportation system of FIG. 1.

FIG. 6 is a flow diagram illustrating a method of use for providing mass transit, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to an electric mass transit system and more particularly to an autonomous networked transportation system and method as used to improve the provision of a mass transit system.

Generally, a transportation system having advantageous features for efficiency, safety, and simplicity of operation is provided. The system is an autonomous transit system utilizing automatically controlled electric vehicles traveling in an enclosed passageway and accessed by restricted access roads. Each vehicle is in some form of electrical communication with a transportation network operation center. This minimizes the time and cost of transitioning to safe autonomous electric transportation. The system uses passageways having individual lanes to which the vehicles are restricted to. The vehicles may be constrained to lanes by governance of the transportation network operation center.

The system uses autonomous electric vehicles which may operate using the same near and opposite fast lanes and rights of way methods of existing urban freeway ring roads. They may utilize bridgework to access near side terminals which service restricted access lanes from local terminals. The vehicles may be constructed aerodynamically and utilize ram-air turbine generators, plasma actuators, regenerative breaking, solar panels and ion type batteries to power autonomous electric rotary motors and/or linear induction motors. Passageway systems may serve to “bundle” vehicles into control groups which operate as a single unit for safety. Vehicles may be lifted, accelerated, and stopped electromagnetically. Vehicles may be privately or collectively owned, operated, and used. No gears or transmission will be required. Brakes may operate conventionally or electromagnetically. Each passageway can feature curved floors, solar panels and vented walls built on the existing freeway lanes and rights of way and accessed form bridgework over middle and near lanes to near side terminals. The terminals may provide regional traffic control, maintenance and services for passengers arriving to and from Restricted Access Lanes. The passageways and terminals may be built with regulations in mind.

The system uses autonomous electric vehicles which may operate using the same near and opposite fast lanes and rights of way methods of existing urban freeway ring roads. They utilize bridgework to access near side terminals which service restricted access lanes from local terminals. The vehicles may be constructed aerodynamically and utilize ram-air turbine generators, plasma actuators, regenerative breaking, solar panels and ion type batteries to power autonomous electric rotary motors and/or linear induction motors. Passageway systems will “bundle” vehicles into control groups which will operate as a single unit for safety. Vehicles may be lifted, accelerated, and stopped electromagnetically. Vehicles may be privately or collectively owned, operated, and used. No gears or transmission will be required. Brakes may operate conventionally or electromagnetically. Each passageway can feature curved floors, solar panels and vented walls built on the existing freeway lanes and rights of way and accessed form bridgework over middle and near lanes to near side terminals. The terminals will provide regional traffic control, maintenance and services for passengers arriving to and from Restricted Access Lanes. The passageways and terminals will be built with regulations in mind. Exact specifications of the transportation may vary upon further development and manufacturing.

Preferably, the vehicles have wheels, each having a dedicated electric motor. Some embodiments may have axles to which the wheels are suspended. In such a case, each motor is directly mounted to an end of an axle. Alternatively, axle-less designs may be used. The electric motors may be mounted within and concentric to a hub assembly or the wheel itself. This structure enables the vehicles to be lightweight and eliminates complicated power transmission mechanisms. Additionally, each motor may be individually governed by the vehicle controller, providing adaptability to the vehicle's operation. For example, this governance may be advantageous for implementing differential functions, traction control, speed limitations, and other functionality.

In some embodiments, the vehicles may incorporate drive mechanisms having linear induction motors which interact with static or electromagnetic rails. The linear induction motors may be incorporated in tandem or in replacement of traditional electric motors.

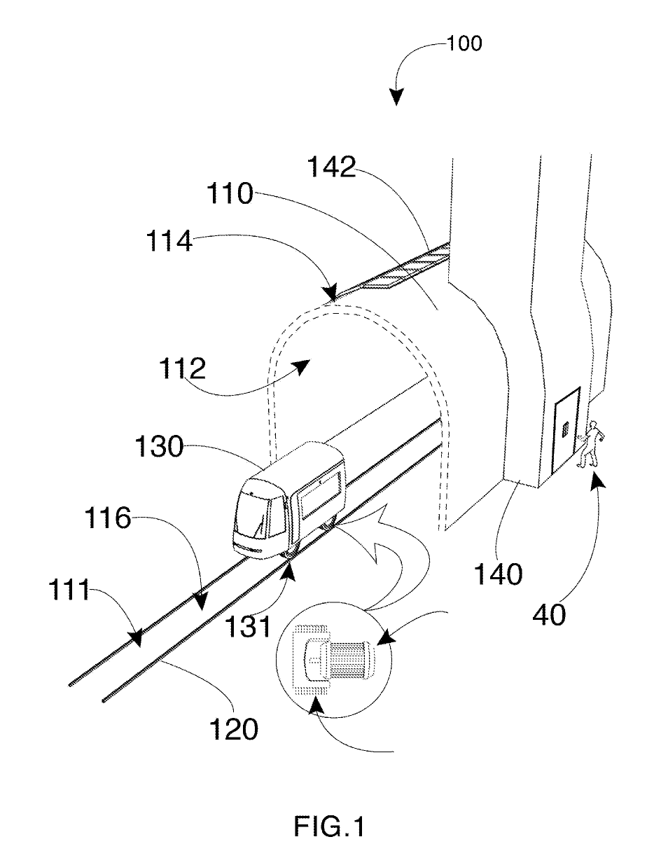

Referring now more specifically to the drawings by numerals of reference, there is shown in FIGS. 1-4, various views of a transportation system 100.

FIG. 1 shows a transportation system according to an embodiment of the present disclosure. Here, the transportation system may be beneficial for use by a user 40 to convey user 40 from an origin to a destination, the transportation system comprising at least one enclosed passageway 110, at least one travel-lane 111, at least one electromagnetic rail 120, at least one vehicle 130, and plurality of passenger terminals 140. At least one enclosed passageway 110 may have interior 112, exterior 114, and floor 116. At least one enclosed passageway 110 may be an underground tunnel or a freestanding structure in various embodiments. One or more external solar panel arrays 142 may be disposed on exterior 114 of at least one enclosed passageway 110. At least one travel-lane 111 may be disposed within at least one enclosed passageway 110, and may be centered within it, contouring a route taken by at least one enclosed passageway 110. At least one travel-lane 111 may be disposed on floor 116. Optionally, multiples of At least one travel-lane 111 may travel side by side within at least one enclosed passageway 110. At least one vehicle 130 may have at least one wheel 131. Electric motor 133 may be disposed adjacent and concentric to at least one wheel 131. Preferable, at least one wheel 131 includes four wheels, each having an independent motor. Preferably, at least one enclosed passageway 110 comprises a network of passageways connecting a large quantity of destinations. Each destination may have at least one of the plurality of passenger terminals 140, such that each one of the plurality of passenger terminals 140 enable passengers to board and exit the at least one vehicle 130 safely. At least one vehicle 130 may be able to contain user 40, and may have an internal cabin area with seats, windows, doorways, and other features usable by user 40. At least one vehicle 130 may be configured to travel along at least at least one travel-lane 111.

Plurality of passenger terminals 140 may be integrated into at least one enclosed passageway 110, being configured to provide user access to at least one enclosed passageway 110. Plurality of passageway terminals 140 may include structural features such as ramps, docks, and closable doorways to enable passengers to safely enter at least one enclosed passageway 110 and safely board at least one vehicle 130. Additionally, plurality of passenger terminals 140 may include docking means to safely secure at least one vehicle 130 to one of the plurality of passenger terminals 140 when one or more passengers are boarding. Such docking means may include mechanical securements or electronic interfaces which are able to govern at least one vehicle 130.

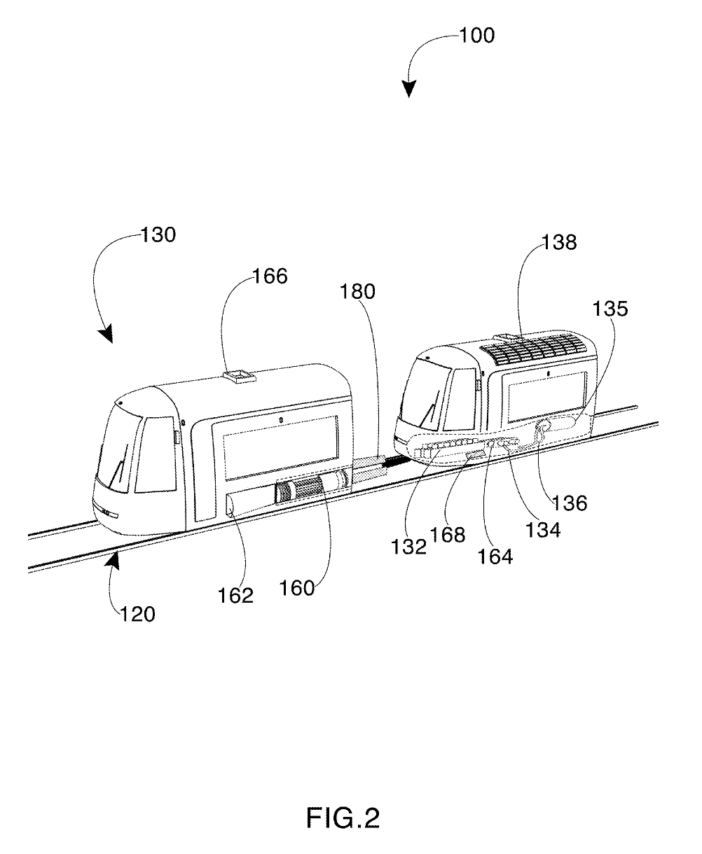

FIG. 2 shows the transportation system of FIG. 1, according to an embodiment of the present disclosure. As above, the transportation system 100 may include at least one vehicle 130. Transportation system 100 may also include electromagnetic rail 120 in some embodiments as illustrated. At least one vehicle 130 may have at least one electric motor 132, energy storage device 134, and braking system 136. At least one electric motor 132 may be configured to propel at least one vehicle 130 along at least one travel-lane 111 (FIG. 1) and alternatively, or in combination with, at least one electromagnetic rail 120. Energy storage device 134 may be electrically coupled to at least one electric motor 132, being configured to provide power to at least one electric motor 132. Power may be provided selectively, enabling an operator to control speeds and direction of at least one electric motor 132. Selection means may be accomplished remotely in some embodiments. Braking system 136 may be configured to decelerate at least one vehicle 130 when activated. Braking system 136 may be a regenerative braking system in some embodiments, supplying power selectively to energy storage device 134.

At least one vehicle 130 may include at least one solar panel array 138. At least one solar panel array 138 may be coupled to energy storage device 134 and may charge energy storage device 134 as at least one solar panel array 138 converts solar radiation to usable electricity. Preferably, the electrical components of at least one vehicle 130 operate using direct current. In some embodiments, circuitry may be implemented to directly power at least one vehicle 130, at least partially or for some systems. However, at least one solar panel array 138 is preferably arranged as a trickle charging device for energy storage device 134.

Energy storage device 134 may be one or more lithium-ion battery 135, and preferably a bank of lithium ion batteries. Such lithium-ion batteries 135 may be wired in parallel to provide greater capacity. Lithium-ion batteries 135 may be charged externally, and potentially by means other than or in conjunction with at least one solar panel array 138.

At least one vehicle 130 may also include turbine generator 160, which may be configured to produce electricity as turbine generator 160 is turned by an airflow. Turbine generator 160 being in electrical communication with energy storage device 134. At least one vehicle 130 may further include ram air system 162, ram air system 162 being configured to channel the airflow into turbine generator 160. Turbine generator 160 may be disposed in a nose of vehicle 130. However, alternative positions may be used. In some embodiments, at least one vehicle 130 further includes regenerative braking system 164. At least one vehicle 130 may further include plasma actuators 166. Plasma actuators may be attached to or integrated with at least one vehicle 130, to an exterior of the at least one vehicle 130 as shown. Controller 168 may be in electrical communication with plasma actuators 166. Plasma actuators 166 may be configured to improve an aerodynamic flow of at least one vehicle 130 when actuated by controller 168. Operation of plasma actuators 166 may reduce drag about at least one vehicle 130. Plasma actuators 166 may be operated by the application of either DC or AC current signals, which may be subject to controller 168. Braking system 136 may be an electromagnetic braking system in some embodiments. Such an electromagnetic braking system may be integral to at least one electric motor 132.

At least one vehicle 130 may further include coupler 180. Coupler 180 may be configured to join multiples of at least one vehicle 130 together. Coupling may be accomplished magnetically. Preferably, coupling of multiples of vehicle 130 together is governed by a remote management system or a human manager able to control multiples of vehicle 130. In such a coupled condition, multiples of at least one vehicle 130 may travel as a unit, which each of at least one vehicle 130 contributing to propulsion of the unit, or alternatively, less than all of the vehicles 130 propelling the unit. In some embodiments, coupling may be able to be accomplished with the vehicles 130 are moving. This would be advantageous, as vehicles 130 approaching from different destinations and then converging for at least a portion of a navigation route may be able to adjoin and travel together, thereby increasing efficiency in power consumption, while reducing effective rail traffic and preventing risk of collisions or speed deviations between adjacent vehicles 130.

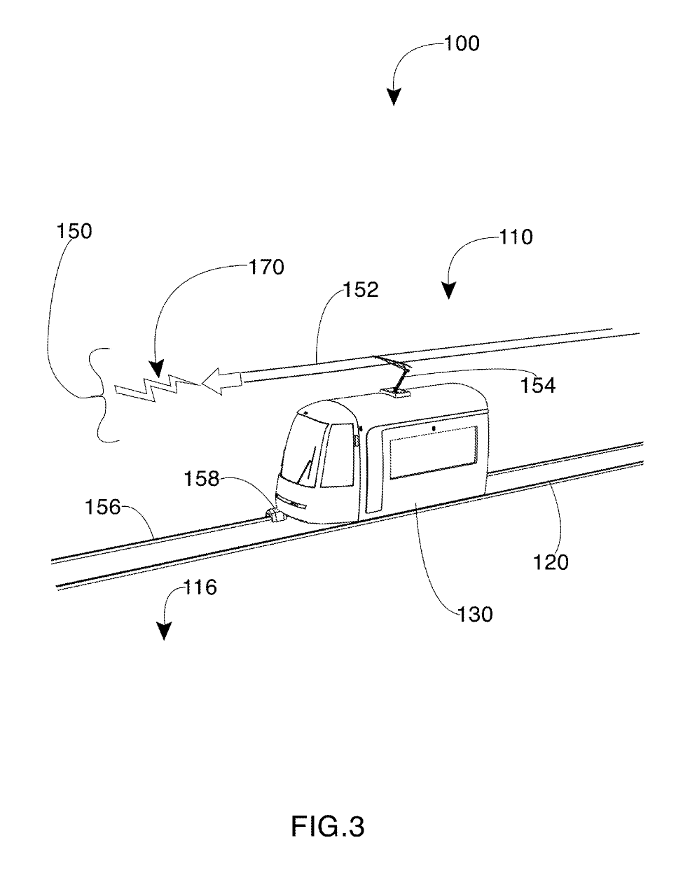

FIG. 3 is a perspective view of the transportation system of FIG. 1, according to an embodiment of the present disclosure. Transportation system 100 may further include power transmission network 150. Power transmission network 150 may be integrated into at least one enclosed passageway 110 and may be in electrical communication with energy storage device 134 (FIG. 2) of at least one vehicle 130 and at least one power source 170, such that at least one power source 170 is able to charge energy storage device 134 of at least one vehicle 130. Optionally, at least one power source 170 may directly power electric motor 132 (FIG. 2), and associated circuitry may be provided. At least one power source 170 may be an external source, such as a power grid. At least one power source 170 may alternatively be one or more generating stations. Yet another alternative is that at least one power source 170 may be one and the same with external solar panel arrays 142 (FIG. 1). The external solar panel arrays 142 (FIG. 1) may be disposed on exterior 114 (FIG. 1) of at least one enclosed passageway 110 (FIG. 1). Combinations of these solution may be implemented.

Power transmission network 150 may include overhead line 152 and pantograph 154 in some embodiments. Overhead line 152 may be electrical communication with at least one power source 170, either constantly or selectively. Overhead line 152 may be suspended from interior 112 of at least one enclosed passageway 110. At least one pantograph 154 in electrical communication with energy storage device 134 (FIG. 2), being structured and arranged to contact overhead line 152 in an in-use condition. At least one pantograph 154 may be mounted to at least one vehicle 130 in such a way to be in constant contact with overhead line 152 even as at least one vehicle 130 travels within at least one passageway 110 (FIG. 1) and at least one pantograph 154 slides along overhead line 152. At least one pantograph 154 may be spring-loaded against overhead line 152, and alternatively or additionally, may include other mechanical retention mechanisms to keep in contact with overhead line 152 as at least one vehicle 130 travels. At least one pantograph 154 may be in electrical communication with overhead line 152 when in contact with overhead line 152, as both at least one pantograph 154 and overhead line 152 are able to conduct electricity. Additionally, or alternatively with regards to overhead line 152 and at least one pantograph 154, power transmission network 150 may include auxiliary rail 156 and at least one sliding-shoe 158. Auxiliary rail 156 may be in electrical communication with at least one power source 170 and may be disposed on floor 116 of at least one enclosed passageway 110 (FIG. 1). As at least one vehicle 130 travels through at least one enclosed passageway 110 (FIG. 1), at least one sliding-shoe 158 slides against and maintains electrical contact with auxiliary rail 156, thereby maintaining at least one electric motor 132 (FIG. 2) of at least one vehicle 130 in electrical communication with at least one power source 170, at least in a selectable and controllable manner. Auxiliary rail 156 may run parallel to at least one electromagnetic rail 120. Alternatively, auxiliary rail 156 may be adjoined with or even integrated with at least one electromagnetic rail 120. Naturally, electrical communication between at least one electric motor 132 (FIG. 2) and at least one power source 170 may be subject to control, disconnection, and graduation by various control and safety mechanisms such as remote controllers and manual operating switches.

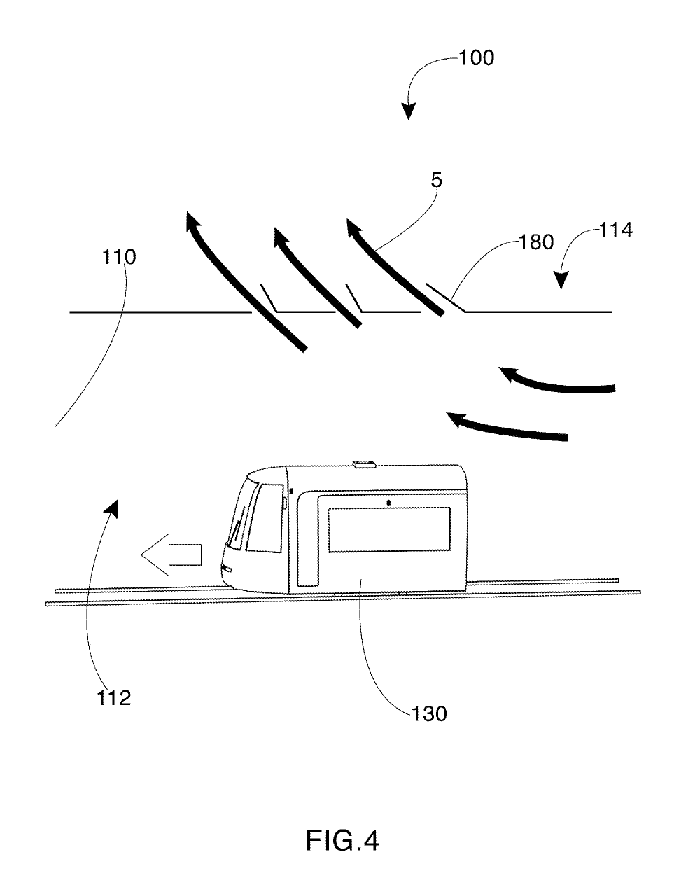

FIG. 4 is a perspective view of the transportation system of FIG. 1, according to an embodiment of the present disclosure. At least one enclosed passageway 110 may further include plurality of vents 180, plurality of vents 180 being configured to allow fluid communication between exterior 114 and interior 112 of at least one enclosed passageway 110. Such fluid communication may improve comfort for passengers traveling within at least one enclosed passageway 110 and circulate fresh air 5 throughout enclosed passageway 110. This may occur passively and may also be assisted by movement of at least one vehicle 130 through at least one enclosed passageway 110.

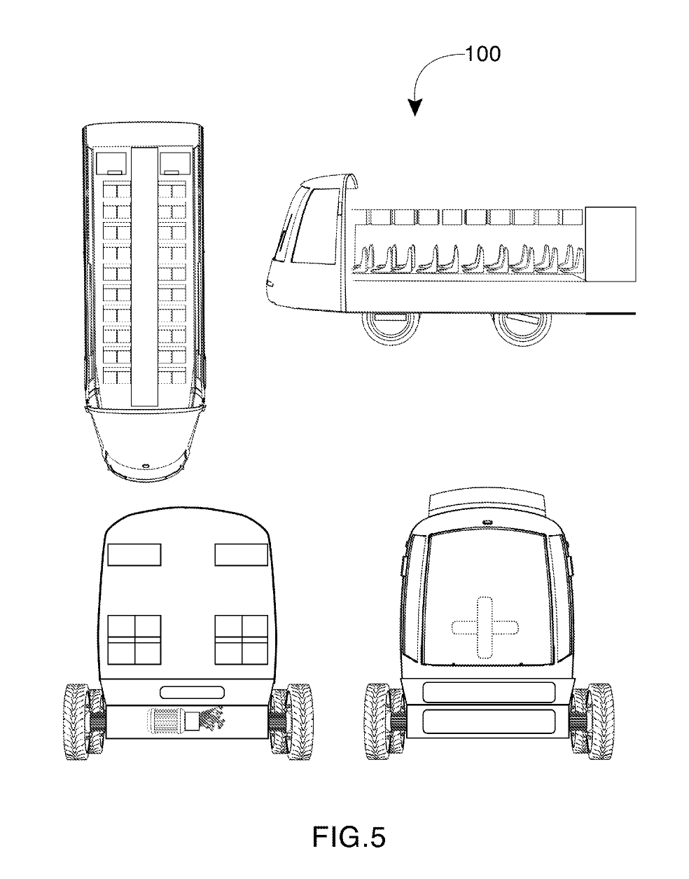

FIG. 5 shows multiple perspective views of the vehicle of the transportation system 100 of FIG. 1, according to an embodiment of the present disclosure. These views illustrate a preferred shape and construction of the vehicles. Each of the vehicles are configured that they may be privately owned in some circumstances, and yet due to their autonomous operation, may be used in conjunction with the transportation to convey other users and passengers when the owner is not operating it. In this way, the owner may receive value from use of the vehicle at all times, even when the owner is not personally using or operating the vehicle.

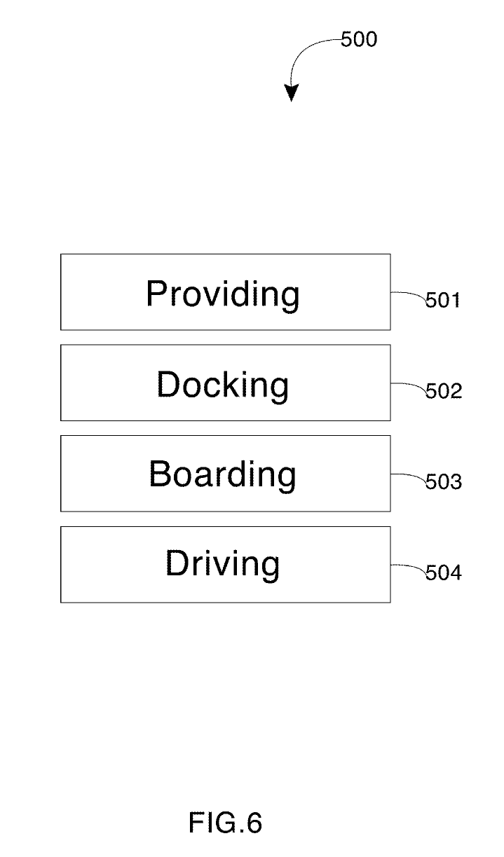

FIG. 6 is a flow diagram illustrating a method for providing mass transit, according to an embodiment of the present disclosure. In particular, the method for providing mass transit 500 may include one or more components or features of the providing mass transit 100 as described above. As illustrated, the method for providing mass transit 500 may include the steps of: step one 501, providing a transportation system able to convey a user from an origin to a destination, the transportation system comprising at least one enclosed passageway having an interior and an exterior, at least one travel-lane, the at least one travel-lane being disposed within the at least one enclosed passageway, and at least one vehicle able to contain the user, the at least one vehicle being configured to travel along the at least one travel-lane, the at least one vehicle having at least one wheel, the at least one wheel being configured to propel the at least one vehicle along the travel-lane, at least one electric motor directly coupled and embedded within the at least one wheel, the at least one electric motor being able to rotate the at least one wheel relative to the at least one vehicle, an energy storage device electrically coupled to the at least one electric motor, the energy storage device being configured to provide power to the at least one electric motor, and a braking system, the braking system being configured to decelerate the at least one vehicle when activated, and a plurality of passenger terminals integrated into the at least one enclosed passageway, the plurality of passenger terminals being configured to provide user access to the at least one enclosed passageway; step two 502, docking the at least one vehicle at one of the plurality of passenger terminals; step three 503, boarding the user from one of the plurality of passenger terminals into the at least one vehicle; and step four 504, driving the electric motor to propel the at least one vehicle along the rail.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for providing mass transit, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A transportation system able to convey a user from an origin to a destination, the transportation system comprising:
at least one enclosed passageway having an interior and an exterior;
at least one travel-lane, the at least one travel-lane being disposed within the at least one enclosed passageway; and
at least one vehicle able to contain the user, the at least one vehicle being configured to travel along the at least one travel-lane, the at least one vehicle having
at least one wheel, the at least one wheel being configured to propel the at least one vehicle along the travel-lane,
at least one electric motor directly coupled and embedded within the at least one wheel, the at least one electric motor being able to rotate the at least one wheel relative to the at least one vehicle;
an energy storage device electrically coupled to the at least one electric motor, the energy storage device being configured to provide power to the at least one electric motor, and
a braking system, the braking system being configured to decelerate the at least one vehicle when activated; and
a plurality of passenger terminals integrated into the at least one enclosed passageway, the plurality of passenger terminals being configured to provide user access to the at least one enclosed passageway.

2. The transportation system of claim 1, wherein the at least one vehicle further comprises at least one solar panel array, the at least one solar panel array being coupled to the energy storage device, the at least one solar panel array being configured to charge the energy storage device.

3. The transportation system of claim 1, wherein the energy storage device comprises at least one lithium-ion battery.

4. The transportation system of claim 1, further comprising a power transmission network, the power transmission network being integrated into the at least one enclosed passageway, the power transmission network being in electrical communication with the energy storage device of the at least one vehicle and at least one power source, such that the at least one power source is able to charge the energy storage device of the at least one vehicle.

5. The transportation system of claim 4, wherein the at least one power source comprises at least one external solar panel array, the at least one external solar panel array being disposed on the exterior of the at least one enclosed passageway.

6. The transportation system of claim 4, wherein the at least one power source comprises at least one generating station.

7. The transportation system of claim 4, wherein the power transmission network comprises:
an overhead line in electrical communication with the at least one power source, the overhead line being suspended from the interior of the at least one enclosed passageway;
at least one pantograph in electrical communication with the energy storage device, the at least one pantograph being structured and arranged to contact the overhead line in an in-use condition, the at least one pantograph being in electrical communication with the overhead line when in contact with the overhead line.

8. The transportation system of claim 4, wherein the power transmission network comprises:
an auxiliary rail in electrical communication with the at least one power source, the auxiliary rail being disposed on a floor of the at least one enclosed passageway;
at least one sliding-shoe in electrical communication with the energy storage device, the at least one sliding-shoe being structured and arranged to contact the auxiliary rail in an in-use condition, the at least one sliding-shoe being in electrical communication with the auxiliary rail when in contact with the auxiliary rail.

9. The transportation system of claim 1, wherein the at least one vehicle further includes a turbine generator, the turbine generator being configured to produce electricity as the turbine generator is turned by an airflow, the turbine generator being in electrical communication with the energy storage system.

10. The transportation system of claim 1, wherein the at least one vehicle further includes a ram air system, the ram air system being configured to channel the airflow into the turbine generator.

11. The transportation system of claim 1, wherein the at least one vehicle further includes a regenerative braking system.

12. The transportation system of claim 1, wherein the at least one vehicle further includes plasma actuators integrated into the at least one vehicle and a controller in electrical communication with the plasma actuators, the plasma actuators being configured to improve aerodynamic flow of the at least one vehicle when actuated by the controller.

13. The transportation system of claim 1, wherein the braking system is an electromagnetic braking system.

14. The transportation system of claim 9, wherein the electromagnetic braking system is integral to the at least one electric motor.

15. The transportation system of claim 1, wherein the at least one enclosed passageway further includes a plurality of vents, the plurality of vents being configured to allow fluid communication between the exterior and the interior of the at least one enclosed passageway.

16. The transportation system of claim 1, wherein the at least one vehicle further comprises a coupler, the coupler being configured to join multiples of the at least one vehicle together.

17. The transportation system of claim 1, further comprising at least one electromagnetic rail, the at least one electromagnetic rail being disposed within the at least one enclosed passageway; and at least one linear induction motor, the at least one linear induction motor being configured to propel the at least one vehicle along the at least one electromagnetic rail.

18. An autonomous networked transportation system able to convey a user from an origin to a destination, the autonomous networked transportation system comprising:
at least one enclosed passageway having an interior and an exterior;
at least one travel-lane, the at least one travel-lane being disposed within the at least one enclosed passageway; and
at least one vehicle able to contain the user, the at least one vehicle being configured to travel along the at least one travel-lane, the at least one vehicle having
at least one wheel, the at least one wheel being configured to propel the at least one vehicle along the travel-lane,
at least one electric motor directly coupled and embedded within the at least one wheel, the at least one electric motor being able to rotate the at least one wheel relative to the at least one vehicle;
an energy storage device electrically coupled to the at least one electric motor, the energy storage device being configured to provide power to the at least one electric motor, and
a braking system, the braking system being configured to decelerate the at least one vehicle when activated; and
a plurality of passenger terminals integrated into the at least one enclosed passageway, the plurality of passenger terminals being configured to provide user access to the at least one enclosed passageway;
wherein the at least one vehicle further comprises at least one solar panel array, the at least one solar panel array being coupled to the energy storage device, the at least one solar panel array being configured to charge the energy storage device;
wherein the energy storage device comprises at least one lithium-ion battery;
further comprising a power transmission network, the power transmission network being integrated into the at least one enclosed passageway, the power transmission network being in electrical communication with the energy storage device of the at least one vehicle and at least one power source, such that the at least one power source is able to charge the energy storage device of the at least one vehicle;
wherein the at least one power source comprises at least one external solar panel array, the at least one external solar panel array being disposed on the exterior of the at least one enclosed passageway;
wherein the at least one vehicle further includes a turbine generator, the turbine generator being configured to produce electricity as the turbine generator is turned by an airflow, the turbine generator being in electrical communication with the energy storage system;
wherein the at least one vehicle further includes a ram air system, the ram air system being configured to channel the airflow into the turbine generator;
wherein the at least one vehicle further includes a regenerative braking system;
wherein the at least one vehicle further includes plasma actuators integrated into the at least one vehicle and a controller in electrical communication with the plasma actuators, the plasma actuators being configured to improve aerodynamic flow of the at least one vehicle when actuated by the controller;
wherein the braking system is an electromagnetic braking system;
wherein the electromagnetic braking system is integral to the at least one electric motor;
wherein the at least one enclosed passageway further includes a plurality of vents, the plurality of vents being configured to allow fluid communication between the exterior and the interior of the at least one enclosed passageway; and
wherein the at least one vehicle further comprises a coupler, the coupler being configured to join multiples of the at least one vehicle together.

19. A method of conveying a vehicle to a destination, the method comprising the steps of:
providing a transportation system able to convey a user from an origin to a destination, the transportation system comprising at least one enclosed passageway having an interior and an exterior, at least one travel-lane, the at least one travel-lane being disposed within the at least one enclosed passageway, and at least one vehicle able to contain the user, the at least one vehicle being configured to travel along the at least one electromagnetic rail, the at least one vehicle having at least one wheel, the at least one wheel being configured to propel the at least one vehicle along the travel-lane, at least one electric motor directly coupled and embedded within the at least one wheel, the at least one electric motor being able to rotate the at least one wheel relative to the at least one vehicle, an energy storage device electrically coupled to the at least one electric motor, the energy storage device being configured to provide power to the at least one electric motor, and a braking system, the braking system being configured to decelerate the at least one vehicle when activated, and a plurality of passenger terminals integrated into the at least one enclosed passageway, the plurality of passenger terminals being configured to provide user access to the at least one enclosed passageway;
docking the at least one vehicle at one of the plurality of passenger terminals;
boarding the user from one of the plurality of passenger terminals into the at least one vehicle; and
driving the electric motor to propel the at least one vehicle along the rail.
